(19) United States
(12) Patent Application Publication
(10) Pub. No.: US 2025/0091492 A1
(43) Pub. Date: Mar. 20, 2025

(54) DECORATIVE SEAMS WITH DECORATIVE ELEMENTS

(71) Applicant: LEAR CORPORATION, Southfield, MI (US)

(72) Inventors: Zhang Shifeng, Shanghai (CN); Wu Xian, Shenyang (CN); Chandrashekar Simha, Pudong (CN); Yang Wenjuan, Shanghai (CN); Yang Yong, Shanghai (CN)

(21) Appl. No.: 18/829,565

(22) Filed: Sep. 10, 2024

(30) Foreign Application Priority Data
Sep. 15, 2023 (CN) 202311195841.8

(51) Int. Cl. B60N 2/58

(52) U.S. Cl. CPC B60N 2/5883; B60N 2/5825; B60N 2/5875

(57) ABSTRACT

An apparatus and method includes securing at least one decorative element to a trim cover to overlay at least a portion of a decorative seam, and securing a retainer to the trim cover and to a seat structure.

### CROSS-REFERENCE TO RELATED APPLICATION

This application is a U.S. non-provisional application claiming the benefit of Chinese Application No. 2023111958418, filed on Sep. 15, 2023, which is incorporated herein by reference in its entirety.

### BACKGROUND

Seats have a trim cover that includes one or more seams. Many different types of seams can be used to join portions of the trim cover together.

### BRIEF DESCRIPTION OF THE DRAWINGS

FIG. 1 is a perspective schematic view of an example seat with seams.

FIG. 2A is an example of a deck seam.

FIG. 2B is an example of a French seam.

FIG. 2C is one example of a crafted stich seam.

FIG. 2D is another example of a crafted stich seam.

FIG. 3 is a section view of a French seam and one example of a retainer.

FIG. 4 is a section view of a French seam with another example of a retainer.

FIG. 5 is a section view of a French seam with another example of a retainer.

FIG. 6A is one example of a decorative element covering a decorative seam.

FIG. 6B is another example of a decorative element covering a decorative seam.

FIG. 6C is another example of a decorative element covering a decorative seam.

FIG. 6D is another example of a decorative element covering a decorative seam.

FIG. 7A is another example of a decorative element covering a decorative seam.

FIG. 7B is another example of a decorative element covering a decorative seam.

FIG. 7C is another example of a decorative element covering a decorative seam.

FIG. 8 is another example of a decorative element covering a decorative seam.

FIG. 9A is one example of a decorative element covering a decorative seam on a seat member.

FIG. 9B is another example of a decorative element covering a decorative seam on a seat member.

FIG. 10 is a section view of one example of a French seam, a retainer, and a seat cushion pad.

FIG. 11 is a section view of another example of a French seam, a retainer, and a seat cushion pad.

FIG. 12 is a section view of another example of a French seam, a retainer, and a seat cushion pad.

FIG. 13 is a section view of an example of a French seam, a ribbon, a retainer, and a seat cushion pad.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be understood that terms such as “about,” “substantially,” and “generally” are not intended to be boundaryless terms, and should be interpreted consistent with the way one skilled in the art would interpret those terms.

This disclosure relates to a seat having a trim cover that includes decorative seams combined with a retainer. The decorative seams may, or may not, include decorative elements. The subject disclosure provides a retainer, such as a tie-down for example, under the decorative seams that is secured by sewing or by sewing combined with a polyurethane reactive (PUR) adhesive. The seams are formed and arranged to provide a desired aesthetic appearance.

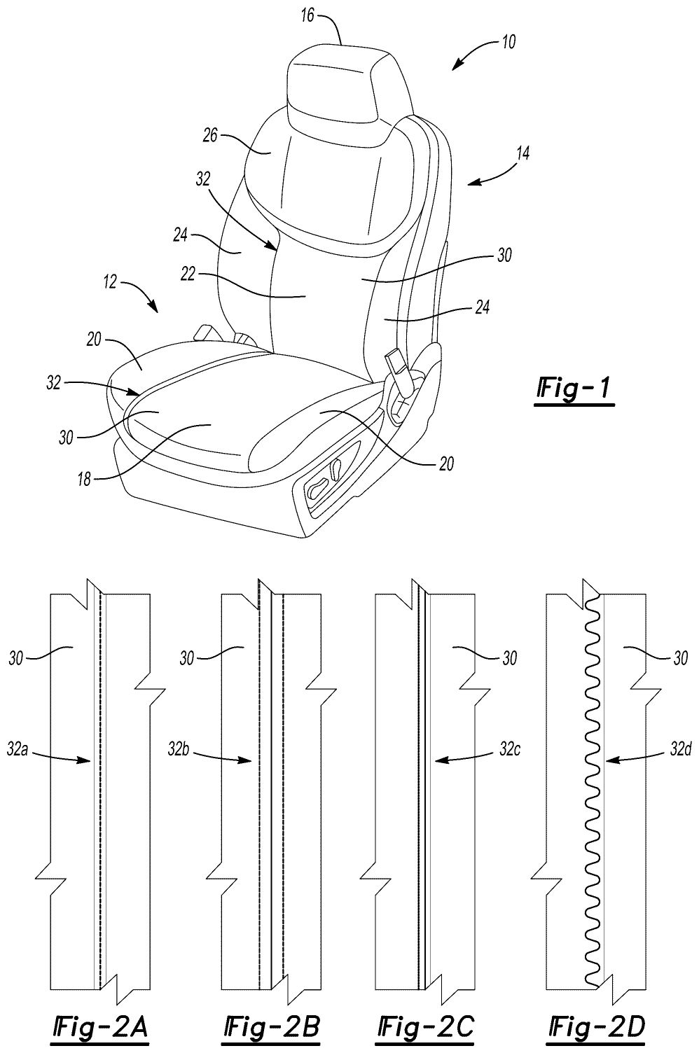

FIG. 1 illustrates a seat assembly 10 according to one example embodiment. The seat assembly 10 may be utilized as a vehicle seat assembly 10 for seating in a vehicle, such as an automobile, an aircraft, a watercraft, or any other seating environment. The seat assembly 10 includes a seat bottom 12 and a seat back 14, which may be pivotally connected to the seat bottom 12 to extend generally upright relative to the seat bottom 12 for pivotal adjustment relative to the seat bottom 12. A head restraint 16 may also be mounted to the seat back 14.

The seat bottom 12 includes a central seating surface 18 and a pair of side bolster regions 20 laterally spaced about the central seating surface 18. The seat back 14 includes a pelvic/lumbar seating surface 22 with a pair of laterally spaced apart side bolster regions 24 on either side. A thoracic/shoulder seating surface 26 is provided above the pelvic/lumbar seating surface 22 and the seating surface of seat back side bolster regions 24. It should be understood that this is just one example of a seat configuration, and that other configurations could also be utilized.

In one example, the seat assembly 10 includes a trim cover 30 with one or more decorative seams 32 as schematically shown in FIG. 1. The trim cover 30 can be comprised of a single layer of material or multiple layers of material. Examples of trim cover material include leather, PVC, PU, textile, or other materials suitable for covering a seat.

Examples of decorative seams are shown in FIGS. 2A-2D. FIG. 2A shows a trim cover 30 with a deck seam 32a. FIG. 2B shows a trim cover 30 with a French seam 32b. FIG. 2C shows a trim cover 30 with one example of a crafted stich seam 32c. FIG. 2D shows a trim cover 30 with another example of a crafted stich seam 32d. The decorative seams 32 can be achieved via a quilting machine, special crafted stitch machine, or normal sewing machine, for example.

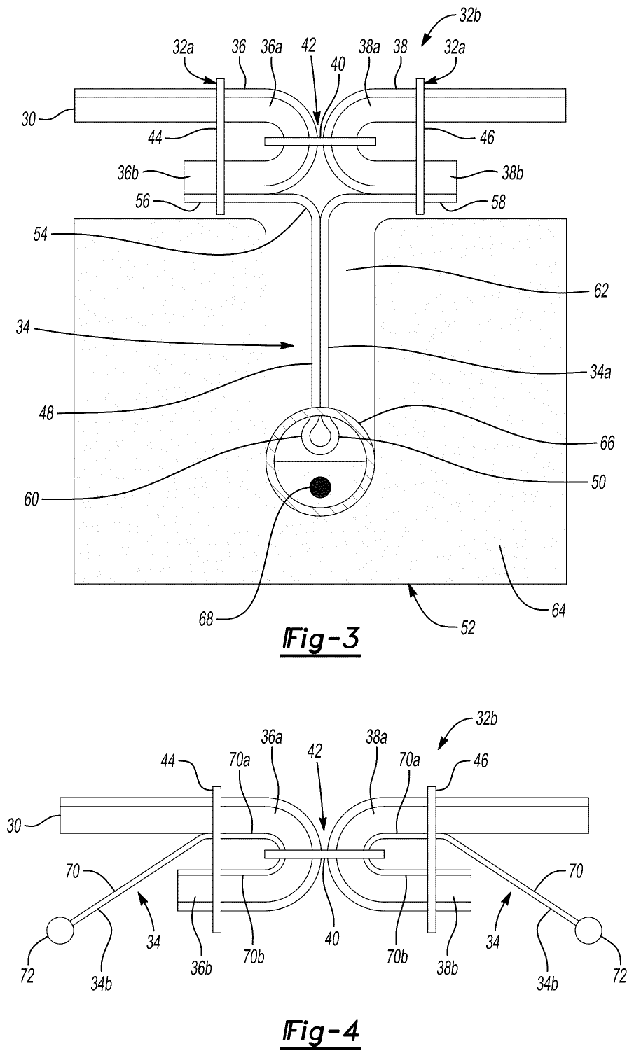

FIGS. 3-5 show examples of a French seam 32b in combination with at least one retainer 34. FIG. 3 shows a trim cover 30 having a first edge 36 aligned with a second edge 38 that are joined together as a French seam. In this example, the first edge 36 is folded such that there are overlapping layers of material 36a, 36b that extend along a length of the seam 32b to form the first edge 36. Similarly, the second edge 38 is folded such that there are overlapping layers of material 38a, 38b that extend along a length of the seam 32b to form the second edge 38. First, the first 36 and second 38 edges are joined together with a first sewing/stitching 40. A trench or gap 42, which faces an exterior surface of the seat, is formed between the edges 36, 38 that are stitched together. Next, a first deck seam 32a, for example, is stitched outward of the first edge 36 along one side of the gap 42 as indicated at 44, and then a second deck seam 32a, for example, is stitched outward of the second edge 38 along an opposite side of the gap 42 as indicated at 46.

The retainer 34 can be comprised of various structures. Examples of retainer types include: Hog ring/PWP (OKE); Listing wire/Pocket; Hook and Loop; Plastic shim/Paddle; Plastic clip; etc.

In the example shown in FIG. 3, the retainer 34 comprises a tie-down 34a. In one example, the tie-down 34a includes a first portion 48 that is securable to the trim cover 30 and a second portion 50 that is securable to a seat structure 52, such as a seat frame, e.g. rigid bar or plate, or seat cushion foundation material for example. In one example, the first portion 48 comprises an upper material portion and the second portion 50 comprises a lower elongated body portion. The upper material portion is comprised of a vertically extending portion of overlapping material 54 that extends from the second portion 50 to a pair of flaps 56, 58 that respectively extend underneath the overlapping layers of material 36a, 36b and 38a, 38b. The first flap 56 is secured to the overlapping layers of material 36a, 36b via the stitching 44 outward of the first edge 36 along one side of the gap 42. The second flap 58 is secured to the overlapping layers of material 38a, 38b via the stitching 46 outward of the second edge 38 along the opposite side of the gap 42. In one example, the elongated body of the second portion 50 comprises a tubular structure or bead 60 that is positioned within a trench 62 of cushion pad 64 that forms the seat cushion. One or more connecting elements 66 secure the bead 60 to an anchor member 68, such as a wire for example, that is embedded within the cushion pad 64 that forms the seat cushion.

In one example, the anchor member 68 comprises a wire embedded in cushion pad 64. For example, the wire comprises a thin filament member extending along a length of the seam 32. In one example, the one or more connecting elements 66 that secure the tie-down 34a to the anchor 66 comprise rings (e.g., rounded members encircling connecting element), staples (e.g., U-shaped member with legs crimped about connecting element), clips (e.g., C-shaped clasp engaging connecting element), etc. The example shown in FIG. 3 comprises a ring.

In one example, the seat cover 30 cushion pad comprises PU foam, reticulated foam, 3D Spacer, Hacoflex, Multiknit, or other types of material suitable for a seat.

FIG. 4 is similar to FIG. 3 but shows another example of a retainer 34b. In this example, the retainer 34b comprises a first portion 70 that that has overlapping layers 70a, 70b inserted between the overlapping layers of material (36a, 36b or 38a, 38b), with the layers 70a, 70b being attached to the trim cover 30 via the stitching 44 or 46. The retainer 34b includes a second portion 72 that is similar to the second potion 50 shown in FIG. 3. The second portion 72 is attached to the anchor member 68 in a manner similar to that of FIG. 3. FIG. 4 shows an example where there is a retainer 34b positioned on each side of the gap 42; however, there may be only one retainer 34b on either side of the gap 42.

FIG. 5 is similar to FIG. 4 but shows another example of a retainer 34c. In this example, the retainer 34c comprises a first portion 70 with one layer of material 70c inserted between the overlapping layers of material (36a, 36b or 38a, 38b), with the layer 70c being attached to the trim cover 30 via the stitching 44 or 46. The retainer 34c includes the second portion 72 that is attached to the anchor member 68 in a manner similar to that of FIG. 3. FIG. 5 shows an example where there is a retainer 34c positioned on each side of the gap 42; however, there may be only one retainer 34c on either side of the gap 42.

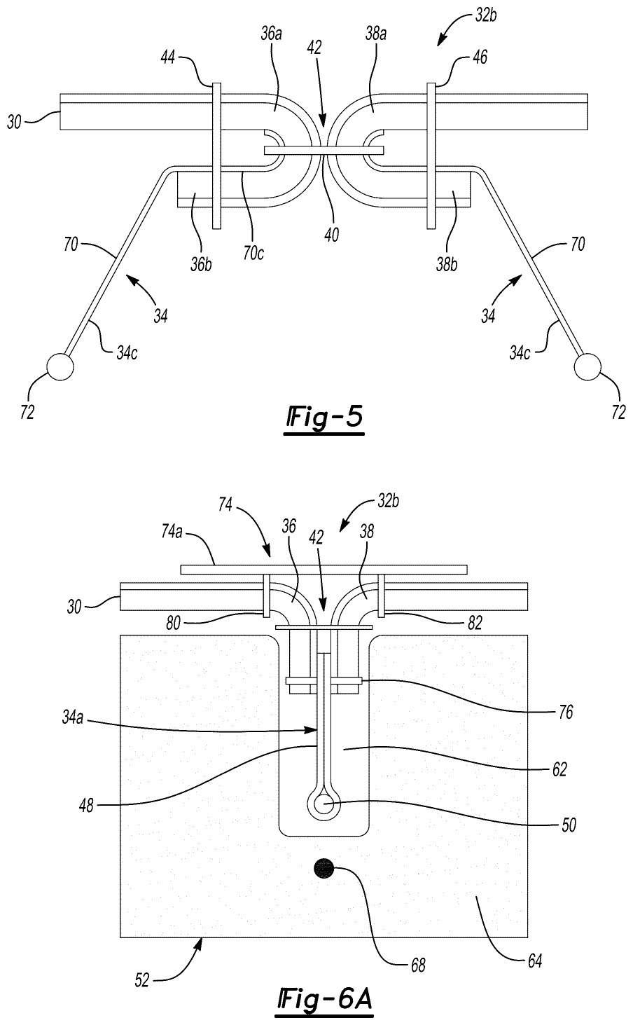

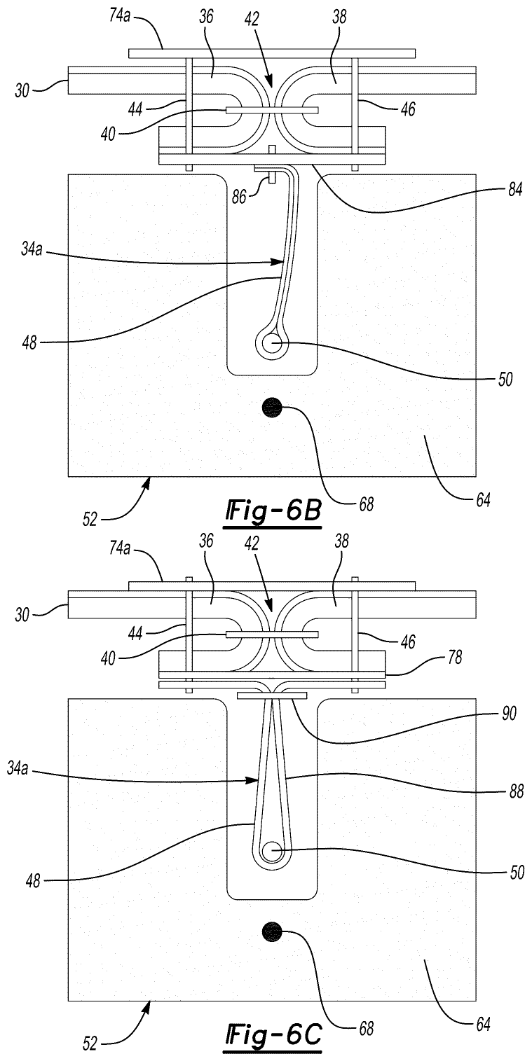

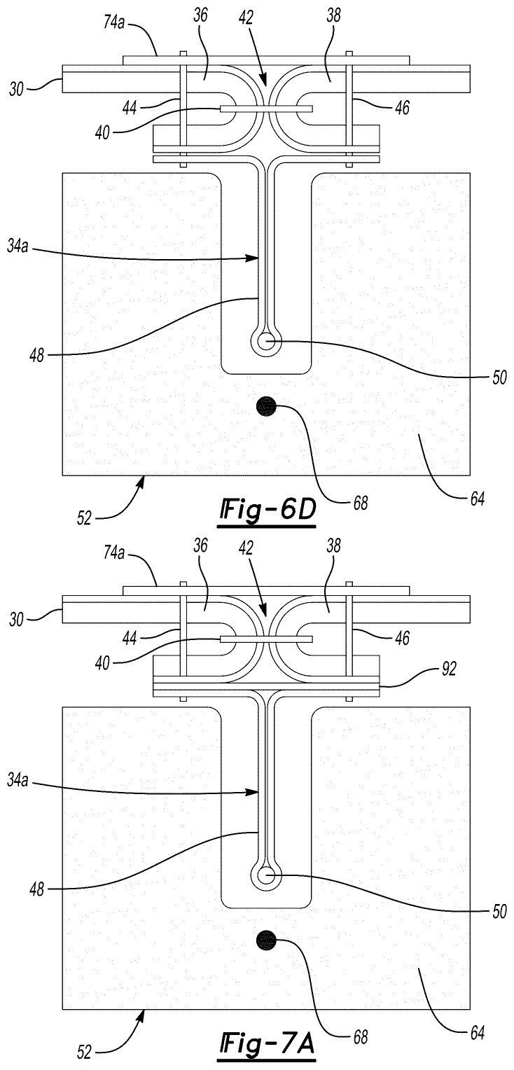

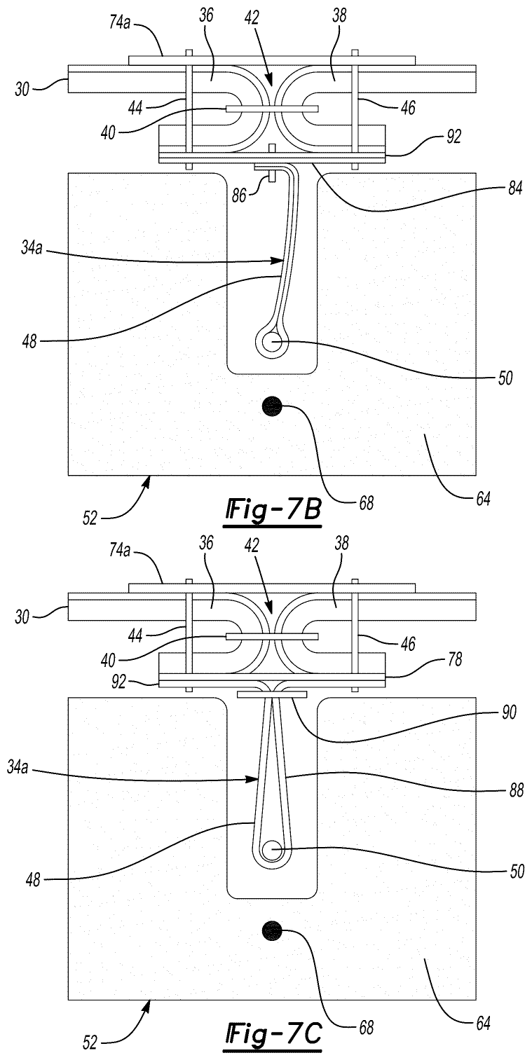

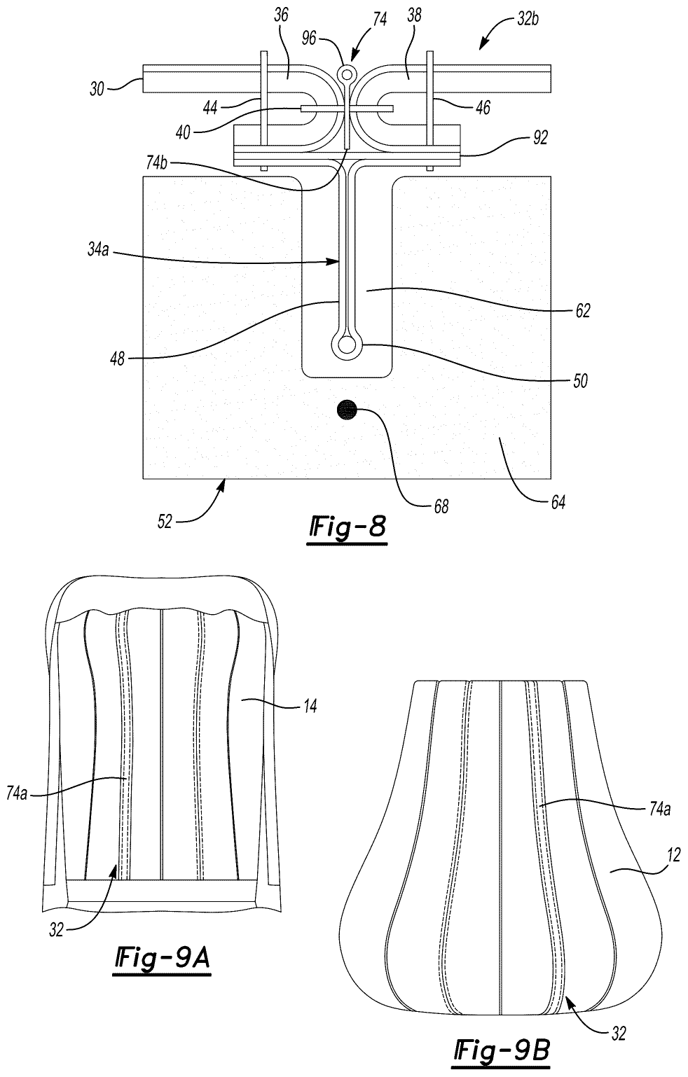

At least one decorative element 74 (FIGS. 6A-6D, 7A-7C, and 8), such as ribbon (FIGS. 6A-6D, 7A-7C) or piping (FIG. 8) for example, is secured to the trim cover 30 to overlay, e.g. extend on top of, at least a portion of the decorative seam 32. FIGS. 6A-6D, 7A-7C show examples where the decorative element 74 comprises ribbon 74a. In one example, the ribbon 74a comprises a flat strip of decorative material that provides a desired aesthetic appearance. Any type of suitable material can be used for the ribbon 74a. FIGS. 6A-6D, 7A-7C show examples of a ribbon 74a that overlays a French seam 32b; however, the ribbon 74a could also be used to overlay any type of seams, such as the examples shown in FIGS. 2A-2D.

FIG. 6A shows an example where the edges 36, 38 of the seam 32b are inserted into the trench 62. In this example, stitching 76 joins the edges 36, 38 together within the trench 62. The ribbon 74a overlies the seam 32b to cover the gap 42 and stitching 80 on one side of the gap 42 secures the ribbon 74a to the trim cover 30, and stitching 82 on an opposite side of the gap 42 secures the ribbon 74a to the trim cover 30. In this example, the first portion 48 of the tie-down 34a extends between the edges 36, 38 and is secured to the trim cover 30 via the stitching 76. The elongated body of the second portion 50 of the tie-down 34a is secured to the anchor member 68, e.g. a wire, that is embedded within the cushion pad 64 that forms the seat cushion as shown in FIG. 3.

FIG. 6B shows an example with a French seam 32b as shown in FIG. 3. In this example, scrim/fleece 84 is positioned underneath the overlapping edges 36a, 36b and 38a, 38b. The scrim/fleece 84 is used for reinforcing or increasing the strength of the tie down 34a. The ribbon 74a overlies the seam and covers the gap 42, and the ribbon 74a and the scrim/fleece 84 are secured to the trim cover 30 via the stitching 44, 46. In this example, the first portion 48 of the tie-down 34a is connected to the scrim/fleece 84 via stitching 86. The elongated body of the second portion 50 of the tie-down 34a is secured to the anchor member 68 embedded within the cushion pad 64.

FIG. 6C shows an example with a French seam 32b as shown in FIG. 3. In this example, tape 78 secures the edges 36, 38 of the trim cover 30 to the flaps 56, 58 of the first portion 48 of the tie-down 34a. The ribbon 74a overlies the seam and covers the gap 42, and the ribbon 74a is secured to the trim cover 30 via the stitching 44, 46. The stitching 44, 46 also is through the tape 78. The tape 78 increases/reinforces the strength of the seam 32a. In this example, the first portion 48 of the tie-down 34a comprises a loop of material 88 that extends around the elongated body of the second portion 50 and with upper portions of the looped material 88 being attached to each other with stitching 90. The elongated body of the second portion 50 of the tie-down 34a is secured to the anchor member 68 embedded within the cushion pad 64.

FIG. 6D shows an example similar to that of FIG. 6C but without the tape 78.

FIGS. 7A-7C show examples of sewing and PUR adhesive being used with the decorative elements 74 and tie-downs 34.

FIG. 7A shows an example that is similar to FIG. 6D. In this example, a layer of PUR adhesive 92 is applied between the edges 36, 38 of the trim cover 30 and the flaps 56, 58 of the first portion 48 of the tie-down 34a.

FIG. 7B shows an example that is similar to FIG. 6B. In this example, a layer of PUR adhesive 92 is applied between the scrim/fleece 84 and the edges 36, 38 of the trim cover 30.

FIG. 7C shows an example that is similar to FIG. 6C. In this example, a layer of PUR adhesive 92 is applied in combination with using the tape 78.

FIG. 8 shows an example where the decorative element 74 comprises piping 74b. FIG. 8 shows an example with a French seam 32b as shown in FIG. 3. In one example, the piping 74b comprises folded material having an exposed fold portion 96 forming a rib or pipe along the seam 32 and overlying edges of the folded material secured to the trim cover 30 underneath rib/pipe with the stitching 40. This example may also include a layer 92 of PUR adhesive as needed.

FIG. 9A shows an example of ribbon 74a extending along a decorative seam 32 on a seat back 14. FIG. 9B shows an example of ribbon 74a extending along a decorative seam 32 on a seat bottom 12. The decorative seams 32 with the associated overlying decorative elements 74 can be located on an insert, shoulder, or bolster seating surface. By using the combination of the decorative element 74 over the decorative seam 32 with a retainer 34, the surface of the seat is flat and does not appear to be pulled down by the retainer. Surface softness is maintained as there is no thickness build up or uneven surface under decorative seam/decorative element. Further, using the retainer 34 keeps the decorative seam 32 and decorative element 34 from meandering and there are no needle holes. Additionally, the design meets scan vs seat trim outline (STO) tolerances.

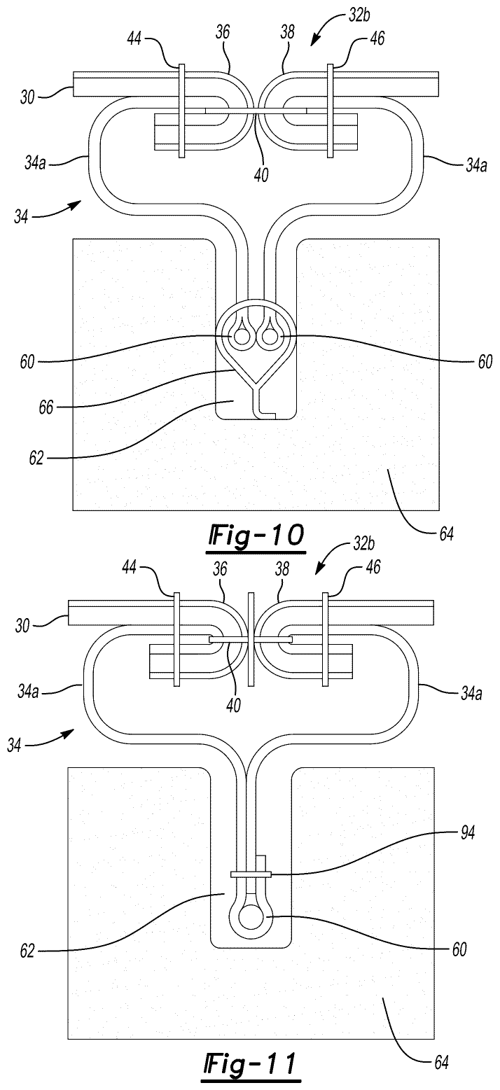

FIGS. 10-13 show additional examples of a French seam 32b in combination with one or more retainers 34 as related to a seat cushion pad 64. The retainer 34 can be comprised of various structures. FIG. 10 shows a trim cover 30 having a first edge 36 aligned with a second edge 38 that are joined together as a French seam. In this example, the first edge 36 is folded such that there are overlapping layers of material that extend along a length of the seam to form the first edge 36. Similarly, the second edge 38 is folded such that there are overlapping layers of material that extend along a length of the seam to form the second edge 38. First, the first 36 and second 38 edges are joined together with a first sewing/stitching 40. Next, one seam 44 is stitched outward of the first edge 36 and then another seam 46 is stitched outward of the second edge 38.

In the example shown in FIG. 10, the retainer 34 comprises tie-downs 34a. In one example, the tie-down 34 is securable to the trim cover 30 and to the cushion pad 64. In one example, each tie-down 34a comprises an upper material portion attached to the trim cover and a tubular structure or bead 60 that can be secured to the cushion pad 64. In this example, upper material portions of each tie-down 34a extend between the overlapping portions of the edges 36, 38, and the beads 60 are coupled together with one or more connectors 66, e.g. rings, clips etc., that secure the tie-downs 34a to the cushion pad 64 via an anchor or wire (see FIG. 3).

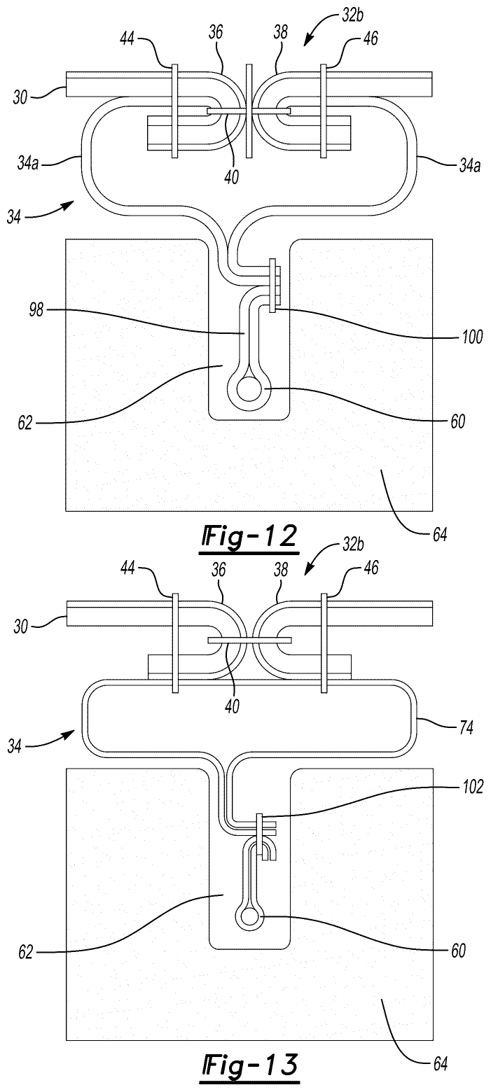

FIG. 11 shows an example similar to FIG. 10 but the material portions of the tie-downs 34a are wrapped around only one bead 60 and overlapping ends are stitched together as indicated at 94. FIG. 12 shows an example where the bead 60 has a material portion 98 that is secured to the material portions of the tie-downs 34a with stitching as indicated at 100. FIG. 13 shows an example where a wider ribbon 74 is fixed under the French seam 32b by a special tool and is coupled to a tie-down 34 as indicated at 102.

An example method for combining decorative seams with decorative elements includes securing at least one decorative element 74 to a trim cover 30 to overlay at least a portion of a decorative seam 32, and securing a first portion 48 of a retainer 34 to the trim cover 30 and a second portion 50 of the retainer 34 to a seat structure 52, e.g., cushion/foam, frame.

Additional method steps may include any of the following in any combination. Sewing, e.g. joining by stitching, the first portion 48 of the at least one retainer 34 to the trim cover 30. Applying a layer of adhesive 92 between the retainer 34 and the trim cover 30. Reinforcing at least one of the at least one decorative seam 32 and the at least one retainer 34. Extending the elongated body of the second portion 50 underneath the at least one decorative seam 32, joining the material of the retainer 34 to the trim cover 30, coupling the material to the elongated body, and connecting the elongated body to the seat structure 52. Extending the ribbon 74a or piping 74b along an exposed surface of the at least one decorative seam 32, and joining the ribbon 74a or piping 74b to the trim cover 30.

In one example, the disclosure provides a combination of a decorative seam in combination with a retainer, such as a tie-down. In another example, the subject disclosure provides a combination of a decorative element 74 over a decorative seam 32 coupled to a retainer 34, which is achieved by sewing or sewing and PUR glue technology. Seat surfaces have concavity which requires the trim to be tied down to seat foundation material along styling elements to achieve design STO tolerances. The combination satisfies craftsmanship expectations for static and dynamic, e.g. seat function, conditions across durability cycles. The combination also ensures a desired shape is achieved, and that there are not any issues with floating or comfortable touch feeling.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An assembly comprising:
a trim cover including at least one decorative seam;
at least one decorative element secured to the trim cover to overlay at least a portion of the at least one decorative seam; and
at least one retainer along the at least one decorative seam.

2. The assembly of claim 1, wherein the at least one decorative seam comprises one or more deck seams, crafted stitch seams, or French seams.

3. The assembly of claim 1, wherein the at least one decorative element comprises ribbon or piping.

4. The assembly of claim 1, wherein the at least one retainer is attached to the trim cover with stitching.

5. The assembly of claim 1, including a layer of adhesive between the at least one retainer and the trim cover.

6. The assembly of claim 1, wherein the at least one retainer is attached to a seat structure with one or more connectors.

7. The assembly of claim 6, wherein the seat structure comprises a seat frame or a wire embedded in cushion material, and wherein the one or more connectors comprise one or more clips, staples, rings, shims, or paddles.

8. The assembly of claim 1, wherein the at least one decorative element is sewn to the at least one retainer.

9. The assembly of claim 1, including at least one seam reinforcement or at least one retainer reinforcement.

10. The assembly of claim 9, including the at least one seam reinforcement and the at least one retainer reinforcement.

11. The assembly of claim 9, wherein the at least one seam reinforcement or the at least one retainer reinforcement comprises tape, scrim, or fleece material.

12. The assembly of claim 1, wherein the at least one decorative seam with an associated overlying decorative element is located on an insert, shoulder, or bolster seating surface.

13. An assembly comprising:
a trim cover including at least one decorative seam; and
at least one tie-down along the at least one decorative seam.

14. The assembly of claim 13, wherein the at least one tie-down comprises an elongated body extendable along a length of the at least one decorative seam and material securable to the trim cover and the elongated body, and including at least one decorative element secured to the trim cover to overlay at least a portion of the at least one decorative seam.

15. A method comprising:
securing at least one decorative element to a trim cover to overlay at least a portion of a decorative seam; and
securing a retainer to the trim cover and to a seat structure.

16. The method of claim 15, including sewing the retainer to the trim cover.

17. The method of claim 16, including applying a layer of adhesive between the retainer and the trim cover.

18. The method of claim 15 including reinforcing at least one of the decorative seam and the retainer.

19. The method of claim 15, wherein the retainer comprises at least one tie-down with material and an elongated body, and including:
extending the elongated body underneath the decorative seam;
joining the material to the trim cover;
coupling the material to the elongated body; and
connecting the elongated body to the seat structure.

20. The method of claim 15, wherein:
the decorative seam comprises one or more deck seams, crafted stitch seams, or French seams;
the at least one decorative element comprises ribbon or piping; and
including
extending the ribbon or piping along an exposed surface of the decorative seam, and
joining the ribbon or piping to the trim cover.
